(19) United States
(12) Patent Application Publication
(10) Pub. No.: US 2012/0067484 A1
(43) Pub. Date: Mar. 22, 2012

(54) Sacrificial Layer to Relieve Pinch Flashing in Molding Operations

(75) Inventors: Yue Zhang, Corvallis, OR (US); Ralph Allen Hulseman, Greenville, SC (US)

(73) Assignees: SOCIETE DE TECHNOLOGIE MICHELIN, Clermont-Ferrand (FR); MICHELIN RECHERCHE ET TECHNIQUE S.A., Granges-Paccot (CH)

(21) Appl. No.: 12/884,692

(22) Filed: Sep. 17, 2010

(51) Int. Cl. B60C 5/00; B28B 7/36

(52) U.S. Cl. 152/450; 264/313

(57) ABSTRACT

A method to reduce or eliminate pinch flashing in mold operations by applying a thin coating of a hydrocarbon wax to the outside surface of an uncured rubber article or on the sidewall or shoulder of a green tire at a location(s) where segments of the mold close on each other and on the rubber article or tire during cure. The hydrocarbon wax has a melting point from about 60 degrees to about 80 degrees Celsius, and is compatible with the composition of the rubber. The hydrocarbon wax acts as a sacrificial layer and is scraped up by the mold parts instead of the rubber when the mold segments close.

### BACKGROUND

1. Field of the Invention

The present invention is in the field of curing rubber articles, more particularly tires; and is directed to reducing pinch flashing in segmental molding operations.

2. Description of the Related Art

Rubber articles, such as tires, are vulcanized or cured in a press wherein heat is applied, externally through the tire mold and internally by a curing bladder or membrane, for a certain length of time to effect vulcanization of the article. Presses for tires are well known in the art, and generally employ movable mold halves or segmented mold parts which produce the design features of the tire. The curing presses typically are controlled by a mechanical timer or a programmable logic controller (PLC) which cycles the presses through various steps during which the uncured tire, or green tire as it is commonly called, is shaped and heated at a pressure and temperature for a period of time which is chosen to provide sufficient cure to the tire.

The molds employed are comprised of two or more segments which close inward on the uncured tire at the start of cure. When mold segments close on each other and the tire on the sidewall or shoulder regions of the tire, as is typically the case when segmented molds are used, unless the inner surface circumference of the mold is more than or in perfect match with the outer surface circumference of the green tire, the mold can scrape the sidewall or shoulder of the green tire and remove some rubber from the scraped region. The scraped rubber can remain in the mold after the cured tire is removed, and the now cured scraped rubber will have to be removed from the mold because its presence will cause an imperfection in the next green tire which is cured in the mold. Additionally, the mold can also push rubber from the sidewall or shoulder of the tire into the crease between two closing segments of the mold. This rubber cures and either remains attached to the mold when the cured tire is removed, which necessitates that the mold be cleaned before the next cure, or this rubber remains attached to the tire when it is removed and is seen as a small ridge on the tire. Often, this ridge has to be removed from the cured tire for cosmetic reasons. The process which produces the ridge is called “pinch flashing.”

Even if the mold and the green tire are matched perfectly, over time, the mold segments will wear reducing the inner surface circumference of the mold, and then scraping and pinch flashing can occur. Once started, the problem of pinch flashing will continue.

Thus, the tire industry is faced with the dual problems of cleaning the molds to remove residual cured rubber and of removing pinch flashing from cured rubber articles and tires.

Various solutions have been proposed to eliminate or reduce pinch flashing. One approach is to design a mold with special structural members or parts, such as thermal expansion elements, so that the mold segments do not scrape or pinch the uncured rubber. Another approach is to coat a tire or a mold with lubricants, tire paint compositions or release agent compositions which are intended to permit the mold to slip over the uncured tire when the mold is closed. Some of these compositions contain silicones, pigments, talcs, rubber latexes, surfactants and waxes. These compositions are not completely satisfactory because some of their ingredients, such as silicones, pigments and talcs, can remain on the mold and/or on the cured tire and cause subsequent problems.

### SUMMARY OF THE INVENTION

The invention is directed to a method of reducing or eliminating pinch flashing in mold operations of rubber articles comprising the steps of (a) applying a coating of a hydrocarbon wax on the outside surface of an uncured rubber article on at least one location where pinch flashing occurs, (b) placing the uncured rubber article inside of a curing mold, (c) closing the mold and curing the rubber article and (d) removing the cured rubber article from the mold. The invention also provides an uncured or green tire having a thin coating; i.e. from about 1 to about 3 millimeters thick, of a hydrocarbon wax on the outside of the tire sidewall or shoulder on at least one location where mold segments close on each other and on the tire during cure.

### BRIEF DESCRIPTION OF THE DRAWINGS

FIG. 1(a) shows a schematic of a two-piece segmental mold in an open position with a green tire 100 placed in the mold.

FIG. 1(b) shows a schematic of the segmental mold as in FIG. 1(a) when the mold is almost closed. The two tread segments of the mold are shown to pinch the green tire 100 at locations on the outside of the sidewalls of the tire where the sidewall segments close.

FIG. 2 is a picture of a cured tire wherein pinch flashing 110 occurred along the outside sidewall of the tire when uncured rubber was forced into the crease of a segmented mold when the mold segments closed on each other.

FIG. 3 is a picture of a green tire 100 having a thin layer of a hydrocarbon wax applied to the top outside surface of the tire's sidewall at a location where pinch flashing occurs.

FIG. 4 is a picture which shows that pinch flashing was reduced or eliminated at locations on the cured tire when the wax sacrificial layer was applied to the outside top of the green tire 100 sidewall at the pinch locations before the tire was cured.

FIG. 5 is a chart which shows that the height of the ridge formed by the pinch flashing was reduced in four out of six points on the outside sidewall of the cured tire when the wax sacrificial layer was applied to the outside top of the green tire 100 sidewall at pinch locations before the tire was cured.

### DETAILED DESCRIPTION OF PREFERRED EMBODIMENTS

In the process of curing a rubber article such as a tire using a segmented mold, due to mis-matches in the inside surface circumference of the mold and the outside surface circumference of the tire, scraping of rubber from the sidewall or shoulder area of the green tire 100 can occur and some rubber can be forced into creases between closing segments of the mold. The scraped rubber is cured and can remain in the mold after the tire is removed. This scraped cured rubber must be removed from the mold before the next green tire 100 is cured because its presence can cause imperfections in the next cured tire. Further, uncured rubber can be forced into the creases of the mold segments where it cures and either remains attached to the mold when the cured tire is removed, which necessitates cleaning of the mold, or it remains on the cured tire when the tire is removed from the mold. This rubber is seen as a ridge on the tire at the location(s) where the mold segments closed on each other. The process producing this ridge and the ridge produced is called pinch flashing.

The method of the invention reduces or eliminates the mold scraping and the pinch flashing caused by the mold scraping by using a hydrocarbon wax which is applied before cure on the outside surface of the uncured rubber article or green tire 100 at a location(s) where pinch flashing is known to occur. The hydrocarbon wax acts as a sacrificial layer which is scraped up by the mold instead of the rubber.

The hydrocarbon wax has a melting point above room temperature, and preferably from about 60° Celsius to about 80° Celsius. The hydrocarbon wax is compatible with the rubber composition and can be absorbed into the rubber article or tire during cure. Examples of suitable hydrocarbon waxes are beeswax which has a melting point range from about 62° to about 64° Celsius, and paraffin waxes which have a melting point range from about 61° to about 67° Celsius. Paraffin waxes are sold under the trade names CS-2041 by Chrystal, Inc. and IGI 1246C by The International Group, Inc.

The hydrocarbon wax is applied directly onto the uncured rubber or green tire before cure commences. This can be done by coating the rubber article with the wax at room temperature using a spreading device such as a spatula. Preferably, the wax is heated to its melting point and applied in liquid form as by brushing or spraying on the heated wax, or by other means and methods known to the art for applying viscous liquids. The heated wax then cools down and solidifies so it stays in place on the article.

The hydrocarbon wax is applied in a thin layer of from about 1 millimeter to about 3 millimeters thick onto the green tire 100. More preferred, the thickness of the wax is about 1 to 2 millimeters. A thicker layer of wax, up to about 5 millimeters or more, will also reduce the pinch flashing that can occur, but it is uneconomical and can result in excess wax remaining on the rubber article or the mold which could cause problems. The wax is applied on the rubber article or green tire on at least one outside surface location where the segmental mold pieces close on each other and on the article or green tire 100. The hydrocarbon wax is applied in a band having a width of from about 5 millimeters to about 10 millimeters wide at the location(s); and more preferably from about 3 millimeters to about 5 millimeters on either side of the mold closing location(s).

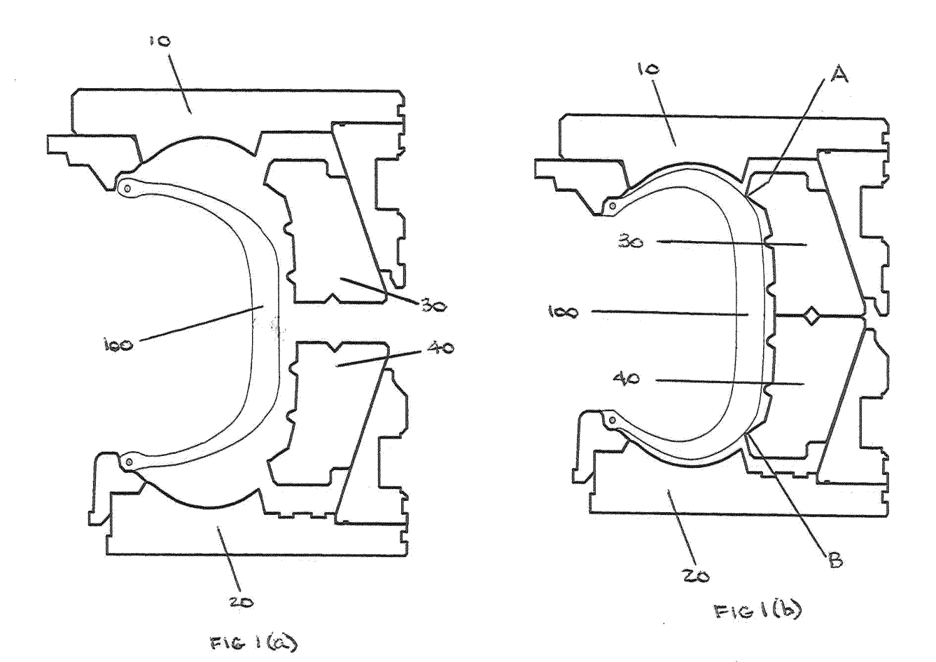

During the curing process, the uncured rubber article or green tire 100 is placed in the mold, and the curing bladder or membrane is partially inflated to shape the article or green tire 100. FIG. 1(a) depicts a green tire 100 placed in a mold. Here, the green tire 100 contacts the mold as the mold closes with the sidewall segments (10 and 20) closing inward and the tread mold segments (30 and 40) also closing inward on the green tire 100. FIG. 1(b) depicts the mold almost closed on the green tire 100, and shows where the tread segments can cause scraping and pinch flashing at locations (A) and (B). The scraping and the pinch flashing occur quickly on closing of the mold, usually within 5 to 20 seconds after closing starts.

As the mold segments continue to close, the segments scrape off the hydrocarbon wax instead of the rubber. Residual hydrocarbon wax on the rubber article or green tire 100 can be substantially absorbed into the tire during cure.

Because the mold segments scrape off the hydrocarbon wax instead of the rubber, no rubber is pushed into the crease between the mold segments as they close on each other. Hence, no pinch flashing of the rubber occurs. If any of the hydrocarbon wax is pushed into the segmental mold creases, it vaporizes if the mold is above 200° Celsius.

The following examples are given to further define the invention and how to use the invention, and are not meant to limit the invention in its scope.

### EXAMPLES

### Example 1

Tests were conducted in a laboratory to explore if some known lubricants or release agents could be used on rubber surfaces to reduce or prevent scrapping of the rubber. Sheets of uncured rubber having a composition similar to a tire sidewall were prepared and placed on a frame. Various materials and compositions were then brushed onto each sheet. Each uncured rubber sheet was then heated to 60° Celsius and a spatula, which was heated to 150° Celsius, was pushed across each sheet at about an angle of 45 to 60 degrees relative to the surface of the sheet to see if the lubricant or composition would allow slippage of the spatula over the uncured rubber and prevent scraping of the uncured rubber by the spatula. The lubricants and compositions tested were: glycerin; a silicone-based release agent; Sprayon S00311 (a polytetrafluoroethylene mold release agent); a lubricating gel as described in United States patent application 2006/0016535, and CS-2041 (a paraffin wax).

Of the materials tested, only the paraffin wax 200 prevented the uncured rubber from being scraped up by the spatula. The paraffin wax 200 has the added feature that it is compatible with the rubber sidewall composition and, hence, any residual wax can be absorbed into the rubber composition.

### Example 2

A preliminary test was conducted in a factory using a two-piece segmental mold for a P225/50R17 tire where a sidewall mold segment and a tread mold segment closed on each other at a circumferential location on the sidewall of the tire. The cure of the green tire 100 in the chosen mold was expected to produce pinch flashing 110 on the outside surface of the top sidewall where it appears as a ridge remaining on the tire after cure.

In the preliminary test, a green tire 100 was coated with the CS-2041 product, which is paraffin wax having a melting point range of from about 61° degrees to about 67° Celsius. The paraffin wax was heated to its melting point, but cooled down to about 50 degrees Celsius when applied using a spatula. The thickness of the wax was about 3 to 5 millimeters. The wax 200 was placed on the green tire 100 around the outside surface circumference of the tire on the top sidewall at a location where pinch flashing was known to occur. The paraffin wax 200 solidified and the coated green tire 100 was placed in the mold. The bladder was inflated driving the green tire outward as the top of the segmental mold closed downward and the tread segment closed inward. After cure at 205° Celsius for about 11 minutes, the tire was removed and the amount of pinch flashing which normally was observed to occur on the tire was reduced.

### Example 3

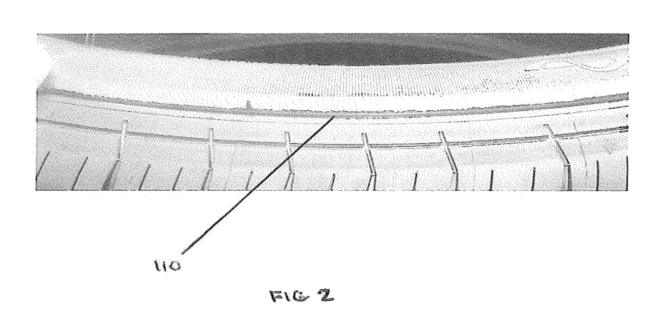

A controlled test was conducted. For this, a green tire 100 similar to that used in Example 2 above was placed in a P225/50R17 segmental mold. No hydrocarbon wax layer was applied to the green tire 100. After cure at 205° Celsius for about 11 minutes, the tire was removed and a small piece of cured rubber was observed attached to the mold at the edge of a top segment and a ridge caused by pinch flashing was observed on one-half of the outside top sidewall of the tire. The ridge ranged in height from about 2 millimeters to about 3 millimeters. This tire was the control tire. The pinch flashing 110 which occurred on the control tire is seen in the picture shown as FIG. 2.

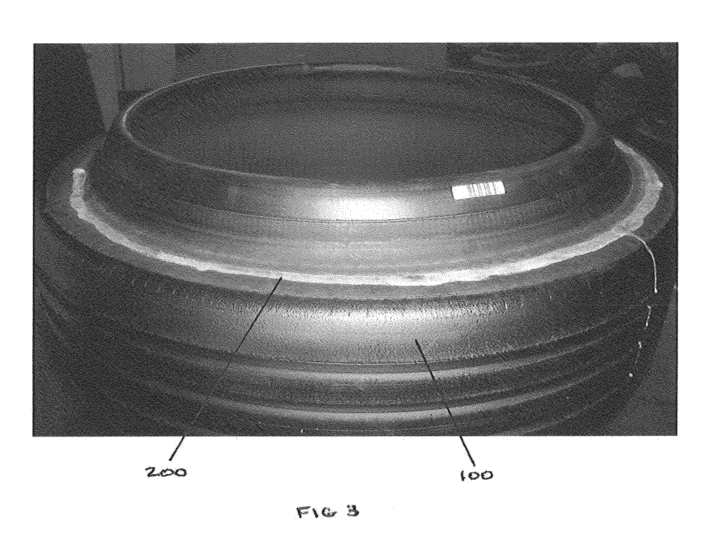

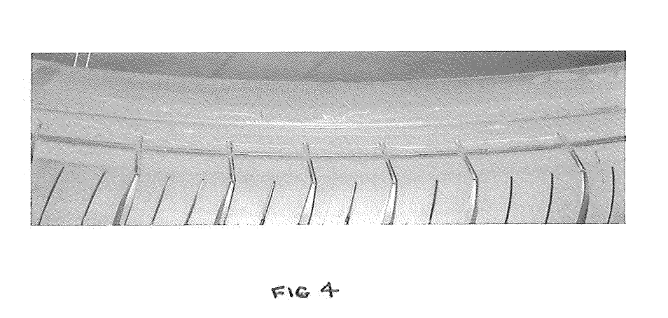

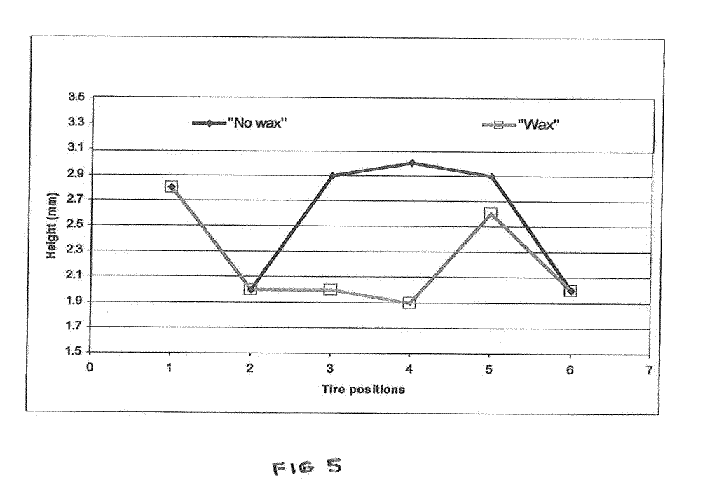

The mold was then cleaned and an identical green tire 100 was prepared to be placed in the mold. This time, the CS-2041 product, a paraffin wax having a melting point range of from about 61° to about 67° Celsius, was applied to the tire around the outside surface circumference of the tire on the top sidewall at locations where pinch flashing was observed on the control tire. The paraffin wax was heated to its melting point and applied onto the tire using a brush and at a thickness of about 1 to 2 millimeters. This variance in thickness was due to the effect of brushing the wax onto the tire. The width of the wax band was about 10 millimeters; i.e. about 5 millimeters on either side of the locations where pinch flashing occurred in the control tire. A silver marking pen was used to outline the wax bands on the green tire 100 so that the effect of the paraffin wax on the degree of pinch flashing in these locations could be readily observed. FIG. 3 shows a picture of the green tire 100 with the wax layer 200 on it. The green tire 100 with the wax layer 200 was placed into the mold, the segmental mold closed and cure commenced in the same manner as with the control tire. After cure, the tire was removed. No cured rubber was observed attached to any mold segment. The tire was inspected. In some of the locations, the wax coating eliminated the pinch flashing. In other locations, some pinch flashing occurred, but the average height of the flash ridge was distinctly lower than that observed on the control tire. A picture of the test tire is shown as FIG. 4.

Measurements were taken on the height of the flashing for both the control tire and the tire made using the paraffin wax sacrificial layer. These measurements were made on the same six points on each tire around one-half of each tire's circumference; i.e. a measurement was made at about every 35 degrees on the tires at locations where pinch flashing occurred in the control tire. As seen in FIG. 4, the use of the paraffin wax reduced the average height of the ridge on four of the six measured points from about 3 millimeters to about 2 millimeters. Further, in other locations on the tire made using the paraffin wax, no pinch flashing was observed.

If the above test is repeated using a thicker coating of paraffin wax on the green tire; i.e. above 3 millimeters thick, reduced pinch flashing is observed, but excess paraffin wax can remain on the cured tire which is not desirable.

We claim:

1. A method of reducing or eliminating pinch flashing which occurs in mold operations of a rubber article comprising the steps of:
applying a coating of a hydrocarbon wax on the outside surface of an uncured rubber article on at least one location where pinch flashing occurs;
placing the uncured rubber article into a curing mold;
closing the mold and curing the rubber article; and
removing the cured rubber article from the mold.

2. The method of claim 1, wherein the rubber article is a tire.

3. The method of claim 1, wherein the hydrocarbon wax is applied on the outside surface of said rubber article in a thickness of from about 1 millimeter to about 3 millimeters.

4. The method of claim 1, wherein the hydrocarbon wax has a melting point above 50 degrees Celsius.

5. The method of claim 1, wherein the hydrocarbon wax is compatible with the composition of the rubber article.

6. The method of claim 1, wherein the hydrocarbon wax is paraffin wax having a melting point of from about 61 degrees and to about 67 degrees Celsius.

7. The method of claim 1, wherein the hydrocarbon wax is applied in a band having a width of from about 5 millimeters to about 10 millimeters at the location(s) where pinch flashing occurs.

8. The method of claim 1, wherein the hydrocarbon wax is heated to its melting point and is brushed or sprayed onto the rubber article.

9. A green tire having a coating of a hydrocarbon wax on it on the outside surface of the tire sidewall or shoulder on at least one location where mold segments close on each other and on the tire during cure.

10. The green tire of claim 9, wherein the hydrocarbon wax is a paraffin wax having a melting point of from about 61 degrees to about 67 degrees Celsius.

11. The method of claim 9, wherein the hydrocarbon wax is applied in a band having a width of from about 5 millimeters to about 10 millimeters at the location(s) on the green tire where pinch flashing occurs.
